(19) United States
(12) Patent Application Publication
(10) Pub. No.: US 2025/0158877 A1
(43) Pub. Date: May 15, 2025

(54) Dynamic Target State Translations

(71) Applicant: Cisco Technology, Inc., San Jose, CA (US)

(72) Inventors: Jeffrey Yi Dar Lo, Cupertino, CA (US); Dan Talayco, Mountain View, CA (US); Robert Rodgers, Mountain View, CA (US); Kyle Andrew Donald Mestery, Woodbury, MN (US); TJ Giuli, Mountain View, CA (US)

(21) Appl. No.: 18/508,130

(22) Filed: Nov. 13, 2023

(51) Int. Cl. H04L 41/08

(52) U.S. Cl. CPC H04L 41/08

(57) ABSTRACT

Devices, systems, methods, and processes for converting target state data are described herein. Network devices are configured with a variety of settings that can be adjusted based on the desired network deployment. These changes can be made by a network engineer, user, or the like. However, the specific commands to adjust the settings are very technical and specific for a user to understand. Thus, the user is presented with an abstract representation of the network that they can understand and adjust to a desired deployment configuration. This abstract network configuration is packaged as element target state data, which is then transmitted and converted to network target state data that is used internally within a controller to route to a network device. The network target state data is converted to a material target state data which can be processed by the network devices to apply the desired settings within the device.

The present disclosure relates to networking. More particularly, the present disclosure relates to dynamically translating target states when configuring network devices.

### BACKGROUND

Configuring network devices can be a challenging task when individuals need to translate abstract configuration ideas into specialized settings. This difficulty arises from the complexity of networking, the lack of standardization among device manufacturers, the potential for human error, and the need for technical expertise in understanding networking principles, protocols, and security. Additionally, incomplete documentation, evolving business requirements, and the need for stringent security configurations add further complexity to the process. Troubleshooting problems that arise from poorly translated abstract concepts and integrating multiple devices into a cohesive network environment can also pose significant challenges. Overall, configuring network devices demands a deep understanding of networking concepts and the ability to bridge the gap between abstract ideas and practical device configurations.

### SUMMARY OF THE DISCLOSURE

Systems and methods for operating illumination devices on various server devices in a sustainable and smart manner to conserve power and indicate provided access in accordance with embodiments of the disclosure are described herein.

In some embodiments, a device, includes a processor, at least one network interface controller configured to provide access to a network, and a memory communicatively coupled to the processor, wherein the memory includes a target state logic. The logic is configured to receive element target state (ETS) data, convert the ETS data to network target state (NTS) data, determine a network configuration based on the NTS data, and convert the NTS data into material target state (MTS) data.

In some embodiments, the ETS data is received from a user configuration interface.

In some embodiments, the user configuration interface is executed within a cloud-based service.

In some embodiments, the cloud-based service is accessible from a web-based interface.

In some embodiments, the user configuration interface is configured to allow for human-readable configuration input.

In some embodiments, the ETS data is based on the human-readable configuration input.

In some embodiments, the NTS data is configured to only be utilized internally within the device.

In some embodiments, target state logic is further configured to transmit the MTS data to one or more network devices on the network.

In some embodiments, the target state logic is further configured to receive updated MTS data from the one or more network devices.

In some embodiments the target state logic is further configured to convert the updated MTS data to updated NTS data.

In some embodiments, the target state logic is further configured to convert the updated NTS data to updated ETS data.

In some embodiments, the target state logic is further configured to transmit the updated ETS data to a user configuration interface.

In some embodiments, the updated ETS data is configured to be presented to a user via a user configuration interface.

In some embodiments, a method of processing target state data includes receiving element target state (ETS) data, converting the ETS data to network target state (NTS) data, determining a network configuration based on the NTS data, converting the NTS data into material target state (MTS) data, and transmitting the MTS data to one or more network devices.

In some embodiments, the network configuration is associated with a plurality of settings of the one or more network devices.

In some embodiments the MTS data is configured to be processed by the one or more network devices.

In some embodiments, the MTS data is further configured to, upon processing by the one or more network devices, to apply the network configuration to the plurality of settings.

In some embodiments, a device includes a processor, at least one network interface controller configured to provide access to a network, and a memory communicatively coupled to the processor, wherein the memory includes a target state logic. The logic is configured to generate a prompt for abstract network configuration input, receive abstract network configuration input data, convert the abstract network configuration data to element target state data, and transmit the element target state data to a target state logic.

In some embodiments, the target state logic is further configured to receive updated ETS data.

In some embodiments, the target state logic is further configured to generate a notification based on the updated ETS data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that a target state logic may operate within in accordance with various embodiments of the disclosure;

FIG. 2 is a conceptual timing diagram representing various signals sent between an actor and a switch agent in accordance with various embodiments of the disclosure;

FIG. 3 is a flowchart depicting a process for dynamically processing target state data in accordance with various embodiments of the disclosure;

FIG. 4 is a flowchart depicting a more detailed process for dynamically processing target state data in accordance with various embodiments of the disclosure;

FIG. 5 is a flowchart depicting a process for utilizing a user interface in accordance with various embodiments of the disclosure; and

FIG. 6 is a conceptual block diagram of a device suitable for configuration with a target state logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can convert target state data from abstract network configuration to executable instructions that can be applied to a network device. For example, when managing networking devices from a cloud portal, the user can be presented with a way to configure the fabric of devices. This includes the ability to design virtual networks, virtual gateways, etc. This configuration is at a higher level which users can understand. The system needs to convert this into a form which can be digested by the devices in the fabric individually, while also working together in fabric configuration. Embodiments described herein allow for the configuration to be transformed from an element target state (understood by the user) into network target state (a middle state for computation by the cloud controller) and finally into material target state (the actual device configuration, which consists of config files, config commands, and other programs to run on the device to achieve the material target state).

By moving all computation and conversion into a cloud controller or similar system, the agent (typically on the network devise themselves) can be made simpler. This is important because an agent is typically harder to update than a cloud controller, and because resources on the network device are often more constrained than they are in a cloud-based setting. Further embodiments take abstract network state input from a user and manipulate this through element target state data, which is still abstract, and realize material target state, which are actual configuration files and commands run on a network device. Thus, a fabric can be explicitly programmed onto various network devices by material target state data via a cloud SaaS controller.

In many embodiments, the cloud-based service can provide a user configuration interface to a user such as, but not limited to, a network engineer, or network administrator. The user configuration interface can receive abstract network configuration data. In many embodiments, the abstract network configuration data is a human-readable configuration input which can be a desired network fabric or other configuration that is currently desired within a network deployment. This human-readable configuration input can be processed to generate element target state (ETS) data. As described in more detail below, the ETS data is an easy representation for users and allows them to understand and configure network devices using a human-readable format.

In various embodiments, the ETS data is transmitted to a cloud-based controller and is converted into network target state (NTS) data. The NTS data is operable by a cloud controller and is often optimized or otherwise configured to be processed within a controller. Subsequently, the controller can convert the NTS data to material target state (MTS) data. The MTS data is often raw device configuration data for the specific network devices affected by the new fabric configuration. Upon completion, the network device can send updated MTS data back to the cloud-based controller, which can convert the updated MTS data into updated NTS data for processing, which can then again be converted to updated ETS data which is presented back to the user. This updated data can include data necessary to generate a notification to the user. The notificaitons can be configured to indicate that the network configuration was applied, the network configuration was not applied, and/or the network configuration had a problem that needs rectifying before it can be applied (such as discovering a network device that doesn't have the requested feature needed for the configuration, etc.).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, functional languages, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

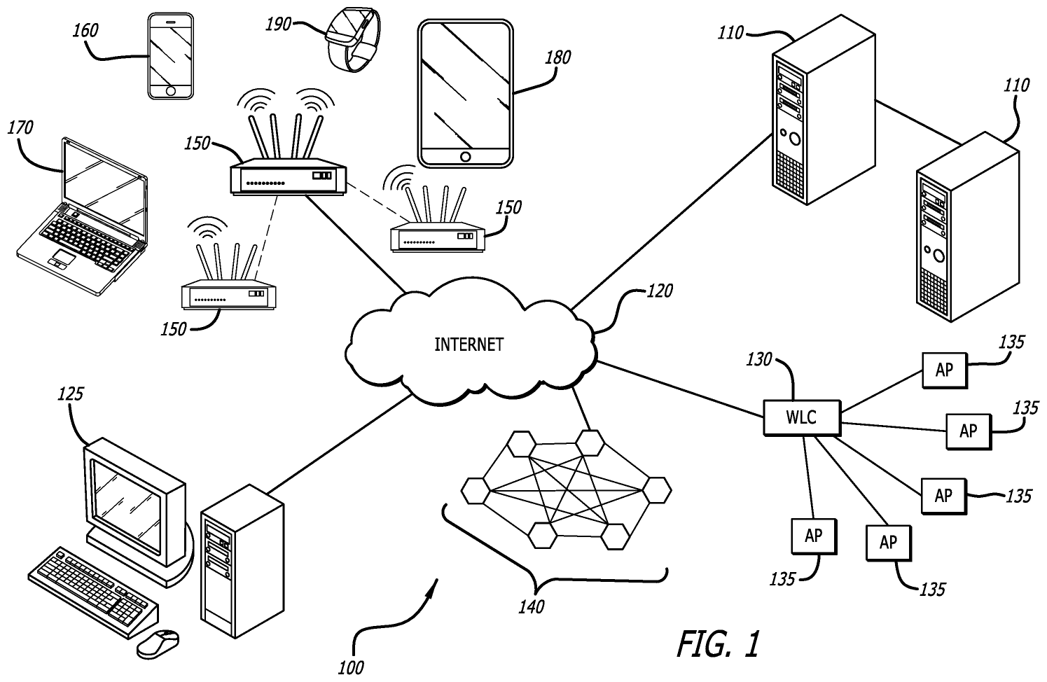

Referring to FIG. 1, a conceptual network diagram of various environments that a target state logic may operate within in accordance with various embodiments of the disclosure in accordance with various embodiments of the disclosure is shown. Those skilled in the art will recognize that a target state logic can be comprised of various hardware and/or software deployments and can be configured in a variety of ways. In some non-limiting examples, the target state logic can be configured as a standalone device, exist as a logic within another network device, be distributed among various network devices operating in tandem, or remotely operated as part of a cloud-based network management tool.

In many embodiments, the network 100 may comprise a plurality of devices that are configured to transmit and receive data associated with various configurations for a plurality of clients and/or network devices. In various embodiments, cloud-based controller servers 110 are connected to a wide-area network such as, for example, the Internet 120. In further embodiments, cloud-based controller servers 110 can be configured with or otherwise operate a target state logic. The target state logic can be provided as a cloud-based service that can provide a web-based interface such as a user configuration interface that can be configured to prompt for and accept human-readable configuration input. This interface can also be configured through a chatbot, or an application, such as a smartphone application or the like. In certain embodiments, the target state logic can be a logic that receives data from a deployed network 140 and generates configurations, and perhaps automates certain dynamic target state data conversions associated with the network devices. In some embodiments, the target state logic can generate network target state (NTS) data and/or material target state (MTS) data in various embodiments and transmit that back to one or more network devices within the deployed network 140 as element target state (ETS) data.

However, in additional embodiments, the target state logic may be operated as distributed logic across multiple network devices. In the embodiment depicted in FIG. 1, a plurality of network access points (APs) 150 can operate as a target state logic in a distributed manner or may have one specific device facilitate the detection of configuration requests or changes for the various network devices. This can be done to provide sufficient needs to the network devices such that, for example, particular service level agreements are adhered to. These network devices may include but are not limited to mobile computing devices including laptop computers 170, cellular phones 160, portable tablet computers 180 and wearable computing devices 190.

In still further embodiments, the target state logic may be integrated within another network device. In the embodiment depicted in FIG. 1, the wireless LAN controller 130 may have an integrated target state logic that it can use to generate configurations, predictions, and perhaps detect configuration requests regarding the various APs 135 that it is connected to, either wired or wirelessly. In this way, the APs 135 can be configured to interact with a user/actor such that configuration requests via ETS data are received and then transferred to the wireless LAN controller 130 for further conversion into NTS and MTS data for application back to the plurality of APs 135. In still more embodiments, a personal computer 125 may be utilized to access and/or manage various aspects of the target state logic, either remotely or within the network itself. In the embodiment depicted in FIG. 1, the personal computer 125 communicates over the Internet 120 and can access the target state logic within the cloud-based controller servers 110, the network APs 150, or the WLC 130 to modify or otherwise monitor the target state logic.

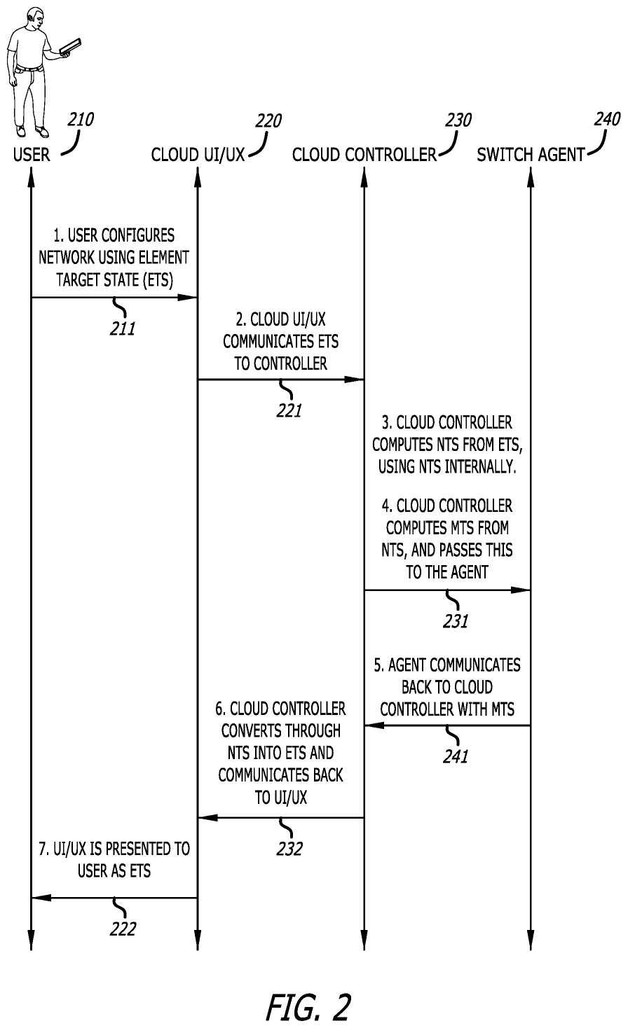

Although a specific embodiment for a conceptual network diagram of various environments that a target state logic may operate within suitable for carrying out the various steps, processes, methods, and operations described herein is discussed with respect to FIG. 1, any of a variety of systems and/or processes may be utilized in accordance with embodiments of the disclosure. For example, the target state logic may be implemented across a variety of the systems described herein such that some configurations are delivered to a user/actor via a cloud-based interface, while other configurations are generated automatically in response to one or more heuristics. The elements depicted in FIG. 1 may also be interchangeable with other elements of FIGS. 2-6 as required to realize a particularly desired embodiment.

Referring to FIG. 2, a conceptual timing diagram representing various signals sent between a user and a switch agent in accordance with various embodiments of the disclosure is shown. In many embodiments, a user 210 or other network engineer/administrator, or the like is utilizing a mobile computing device to access a cloud-based service. In various embodiments, the cloud-based service can present a user configuration interface configured to prompt for and/or accept human-readable configuration input from the user 210.

In more embodiments, the user 210, often by utilizing a target state logic executed within the computing device, can allow the user to configure (211) input as a network configuration by processing it as element target state (ETS) data. In the embodiment depicted in FIG. 2, the ETS data is transmitted to a cloud-based user interface 220 (shown as cloud UI/UX). The cloud-based user interface 220 can be executed from within a target state logic within a remote device over a network, such as the Internet.

In additional embodiments, the cloud-based user interface 220 can be communicatively coupled with a cloud controller 230 which itself can be executing a target state logic. The cloud-based user interface 220 can communicate (221) the ETS data to the cloud controller 230. As discussed below, the ETS data can be in a format that is human-readable or is somewhat abstract in nature compared to the specific instructions that are needed to configure the network devices associated with the ETS data.

In a number of embodiments, the cloud controller 230 can receive ETS data and convert or otherwise compute the ETS data into network target state (NTS) data. As described above, NTS data can be configured to be operable by the cloud controller 230 and otherwise optimized for its internal computations and/or processing. Upon completion of the internal processing of the NTS data, the cloud controller 230 can further convert or otherwise compute material target state (MTS) data based on the NTS data. This MTS data can be passed (231) to the switch agent 240.

In some embodiments, the switch agent 240 can be a specific network device or other logic that is configured to accept MTS data and apply any configurations associated with the MTS data to one or more network devices. In further embodiments, the switch agent 240 is located or otherwise executed from within the target network device itself. As described above, the MTS data can be configured as raw data that can be utilized to directly configure the network device.

In various additional embodiments, the switch agent 240 can communicate (241) back to the cloud controller 230 the MTS data. This MTS data may be augmented to reflect any errors that were not able to be configured. Additionally, certain embodiments may simply return an acknowledgement that the MTS data was successfully processed and the configuration desired by the user 210 was applied.

In still further embodiments, the cloud controller 230 can receive this updated MTS data and convert or otherwise compute the MTS data back into updated NTS data for processing within the cloud controller 230. The cloud controller 230 can process the updated NTS data internally until it converts or otherwise computes the updated NTS data into updated ETS data, which can then be communicated (232) back to the cloud-based user interface 220.

The cloud-based user interface 220 can be the same that was utilized by the user 210 previously. However, in certain embodiments, the updated ETS data can be sent to a different cloud-based user interface 220, such as one operated or otherwise accessed by a network administrator, etc. The cloud-based user interface 220 can format and present (222) to the user 210 as ETS data, which may be configured as abstract network configuration settings that can be easily presented to the user 210.

Although a specific embodiment of a conceptual timing diagram representing various signals sent between a user and a switch agent is described above with respect to FIG. 2, any of a variety of systems and/or processes may be utilized in accordance with embodiments of the disclosure. For example, the specific communication between the various elements can be condensed, such as when a network device hosts the cloud-based user interface 220 and/or the cloud controller 230. The aspects described in FIG. 2 may also be interchangeable with other elements of FIGS. 1 and 3-6 as required to realize a particularly desired embodiment.

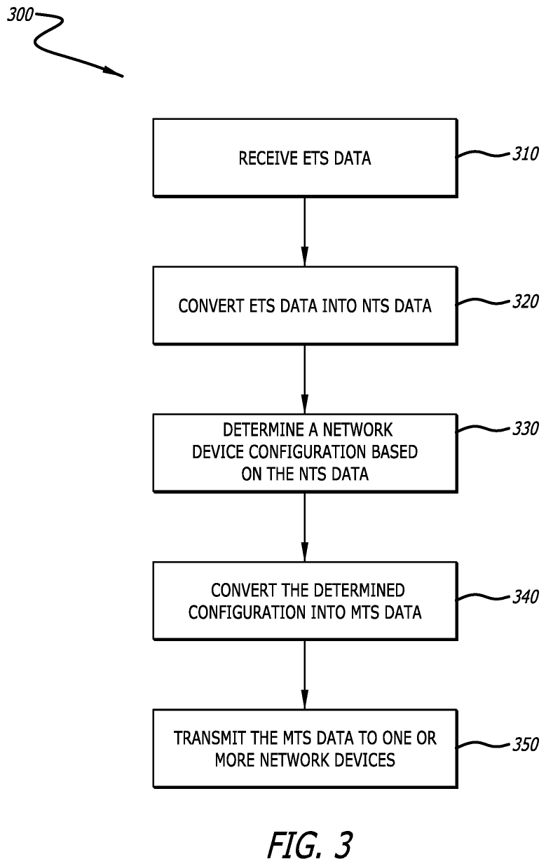

Referring to FIG. 3, a flowchart depicting a process 300 for dynamically processing target state data in accordance with various embodiments of the disclosure is shown. In many embodiments, the process 300 can receive element target state (ETS) data (block 310). For example, the cloud controller described with respect to FIG. 2 is configured to receive ETS data from a user interface system, such as one executed on a cloud-based service and present to the user via a web-based interface.

In a number of embodiments, the process 300 can convert the ETS data into network target state (NTS) data (block 320). As discussed above, the NTS data can be configured to be in a format that is more easily processed internally of the cloud controller or equivalent system. In some embodiments, the cloud controller can utilize the NTS to determine what configurations will be needed within the one or more network devices configured by the user. The cloud controller can operate a target state logic that can have access to data related to, or directly ask various network. For example, a user may desire a particular configuration which may not be possible based on the network devices deployed.

In various embodiments, the process 300 can determine a network device configuration based on the NTS data (block 330). This determination can be a direct configuration option selected by the user. However, there may be some processes or other configuration states that are not available or otherwise selectable by the user. As described in more detail below, this may cause an error to be generated and sent back to the user for notification.

In more embodiments, the process 300 can convert the determined configuration into material target state (MTS) data (block 340). The MTS data can be formatted to be directly applied to one or more network devices with the configuration that was desired by the user via ETS data. This can be in the form of a binary or executable for network devices that can accept such data.

In additional embodiments, the process 300 can transmit the MTS data to one or more network devices (block 350). This transmission can be over a network such as the Internet. However, in certain embodiments, the target state data logic can be present within the network device itself and simply be passed or otherwise executed on the network device itself. In some embodiments the transmission is a direct push transmission to the affected network device itself. However, in more embodiments, the transmission can be a broadcast that the target network device can read and determine that the signal is meant for itself.

Although a specific embodiment for dynamically processing target state data suitable for carrying out the various steps, processes, methods, and operations described herein is discussed with respect to FIG. 3, any of a variety of systems and/or processes may be utilized in accordance with embodiments of the disclosure. For example, the process 300 can be done in parallel or in batches with additional network device configurations such that the resulting MTS data is comprises configurations for multiple network devices. The elements depicted in FIG. 3 may also be interchangeable with other elements of FIGS. 1-2, and 4-6 as required to realize a particularly desired embodiment.

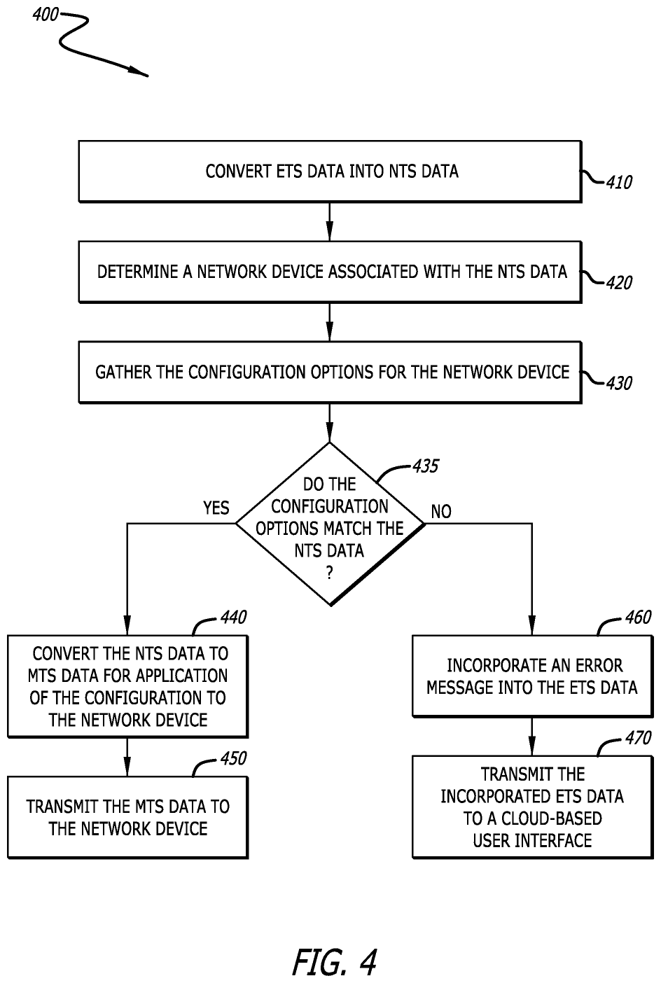

Referring to FIG. 4, a flowchart depicting a more detailed process 400 for dynamically processing target state data in accordance with various embodiments of the disclosure is shown. In many embodiments, the process 400 can convert element target state (ETS) data into network target state (NTS) data (block 410). As described above, ETS data can be configured for more efficient transmission and display to a user via a user interface system, whereas the NTS can be better suited for internal processing.

In a number of embodiments, the process 400 can determine a network device associated with the NTS data (block 420). Often, the NTS data can identify one or more network devices that are intended to be configured/re-configured by the user. The process 400 may be in communication with a plurality of network devices and can determine which of these plurality of network devices is associated with the NTS data and will be receiving material target state (MTS) data at a later time.

In more embodiments, the process 400 can gather the configuration options for the network device (block 430). When it is determined that a network device is going to be configured based on the NTS data, the process 400 can determine if the network device is even capable of accepting or otherwise applying the incoming configuration and/or configuration change. As those skilled in the art will recognize, a network may have various different levels of network devices which may each come with particular features or sub-features that can be utilized.

In some embodiments, the process 400 can determine if the configuration options match the NTS data (block 435). When the configuration options do not match, the process 400 can incorporate an error message into the ETS data (block 460). This updated ETS data can be transmitted back to the user to indicate that a configuration setting will not be implemented and/or to select a different configuration (block 470). However, when the configuration options do match the NTS data, the process 400 can convert the NTS data into material state (MTS) data for application of the configuration to the network device (block 440). Upon conversion, various embodiments can transmit the MTS data to the network device (block 450).

Although a specific embodiment for a more detailed process 400 for dynamically processing target state data suitable for carrying out the various steps, processes, methods, and operations described herein is discussed with respect to FIG. 4, any of a variety of systems and/or processes may be utilized in accordance with embodiments of the disclosure. For example, the error may not be discovered until the MTS data is attempted to be applied to the network device. In these instances, the error message is sent back via updated MTS data, which is then converted to updated NTS data, and final updated ETS data prior to being sent back to the user for notification. The elements depicted in FIG. 4 may also be interchangeable with other elements of FIGS. 1-3 and 5-6 as required to realize a particularly desired embodiment.

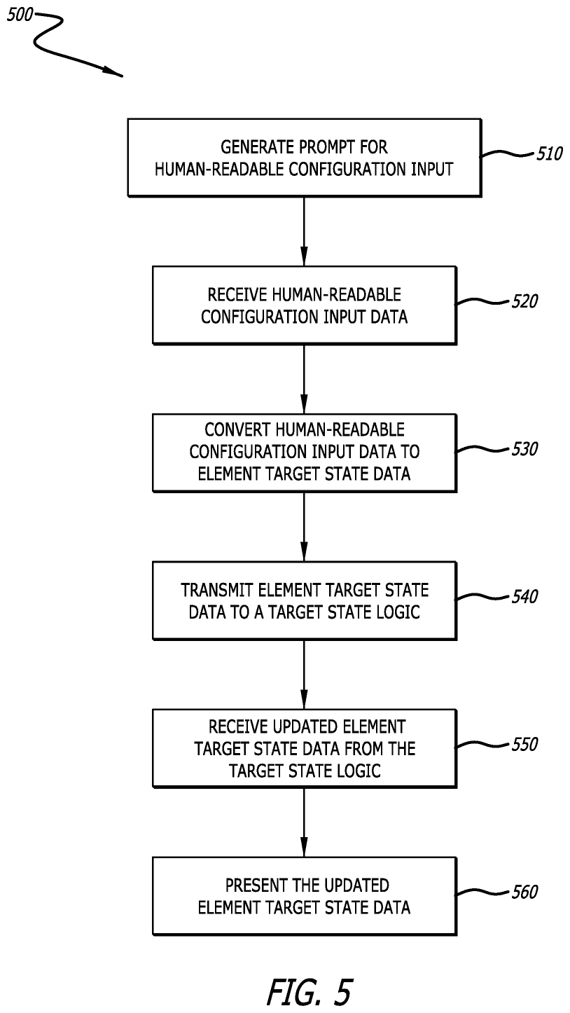

Referring to FIG. 5, a flowchart depicting a process 500 for utilizing a user interface in accordance with various embodiments of the disclosure is shown. In many embodiments, the process 500 can generate prompts for a human-readable configuration input (block 510). As described above, the prompt can be in the form of a user interface, such as a web-based interface provided from a cloud-based service. The prompt can be a part of a specialized network configuration app, but may be configured to allow for the user to enter abstract network configuration parameters that can be further processed and applied to actual network devices.

In a number of embodiments, the process 500 can receive human-readable configuration data (block 520). The data may be received by a person entering selections in a user interface. In some embodiments, the receiving can be done by processing a user-supplied configuration file. In still more embodiments, the receiving can be from a remote device.

In various embodiments, the process 500 can convert the human-readable configuration data into element target state (ETS) data (block 530). In certain embodiments, the human-readable configuration data may already be in the format of ETS data. However, when needed, the specific input data needed for the user interface may be converted into ETS data for transmission or other further processing in abstract form. For example, a web-based user interface may accept the human-readable configuration data through the web portal application, but convert it to ETS for transmission to a cloud-based service.

In more embodiments, the process 500 can transmit the ETS data to a target state logic (block 540). In these embodiments, the transmission may be directly transmitted over a network connection to a specified network device or other cloud-based service. However, in additional embodiments, the ETS data may be broadcast to a number of network devices that can capture and process the ETS data for further processing. In still further embodiments, the web-based user interface and cloud-based service may exist within the same logic or network device such that transmission may be a simple passing of data from one process to another.

In yet further embodiments, the process 500 can receive updated element target state data from the target state logic (block 550). As discussed above, the ETS data can be adjusted or otherwise augmented, such as from the network device or switch agent, etc. This can be a confirmation that the configuration was applied, or it may comprise an error message that the configuration was not able to be applied as desired. This adjusted ETS data may be transferred or otherwise transmitted back to the user via a user interface prompt or other notification, etc.

In still additional embodiments, the process 500 can present the updated ETS data (block 560). As those skilled in the art will recognize, received data can be presented on a graphical user interface, or other user interface type to a user for consumption. In additional embodiments, the ETS data can be presented via a notification on a computing device.

Although a specific embodiment for utilizing a user interface suitable for carrying out the various steps, processes, methods, and operations described herein is discussed with respect to FIG. 5, any of a variety of systems and/or processes may be utilized in accordance with embodiments of the disclosure. For example, the user interface may be executed or otherwise presented from the same device that will carry out, change, and/or apply the desired configuration. In these cases, transmitting and receiving data can be similar to passing variables, data, or other elements between processes within a logic. The elements depicted in FIG. 5 may also be interchangeable with other elements of FIGS. 1-4, and 6 as required to realize a particularly desired embodiment.

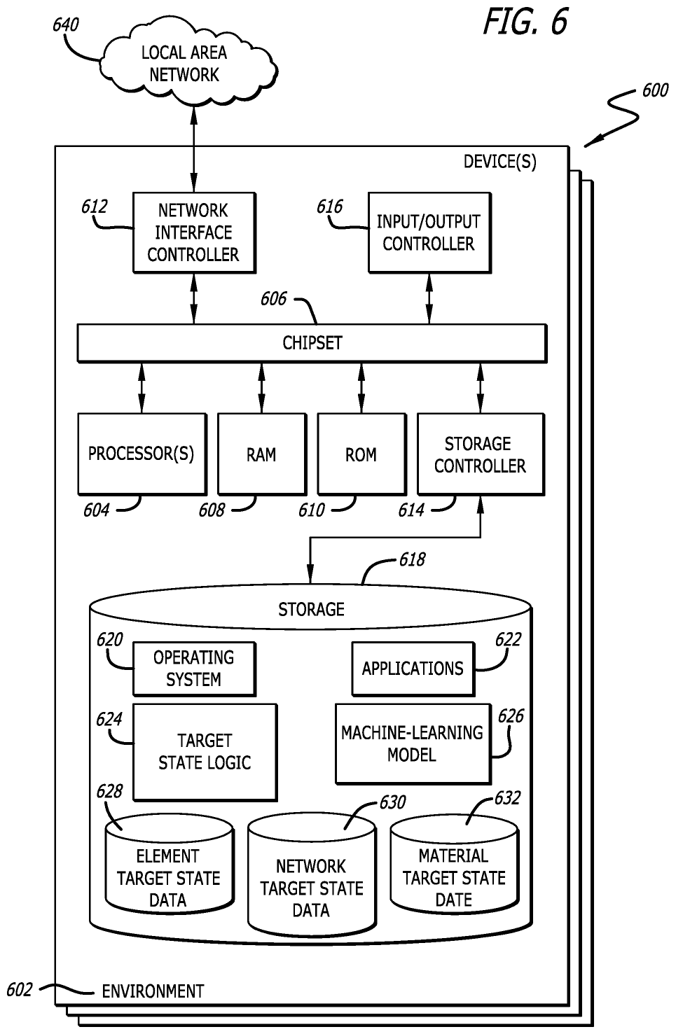

Referring to FIG. 6, a conceptual block diagram of a device 600 suitable for configuration with a target state logic in accordance with various embodiments of the disclosure is shown. The embodiment of the conceptual block diagram depicted in FIG. 6 can illustrate a conventional server computer, workstation, desktop computer, laptop, tablet, network device, access point, router, switch, e-reader, smart phone, centralized management service, or other computing device, and can be utilized to execute any of the application and/or logic components presented herein. The device 600 may, in some examples, correspond to physical devices and/or to virtual resources and embodiments described herein.

In many embodiments, the device 600 may include an environment 602 such as a baseboard or “motherboard,” in physical embodiments that can be configured as a printed circuit board with a multitude of components or devices connected by way of a system bus or other electrical communication paths. Conceptually, in virtualized embodiments, the environment 602 may be a virtual environment that encompasses and executes the remaining components and resources of the device 600. In more embodiments, one or more processors 604, such as, but not limited to, central processing units (“CPUs”) can be configured to operate in conjunction with a chipset 606. The processor(s) 604 can be standard programmable CPUs that perform arithmetic and logical operations necessary for the operation of the device 600.

In additional embodiments, the processor(s) 604 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 606 may provide an interface between the processor(s) 604 and the remainder of the components and devices within the environment 602. The chipset 606 can provide an interface to communicatively couple a random-access memory (“RAM”) 608, which can be used as the main memory in the device 600 in some embodiments. The chipset 606 can further be configured to provide an interface to a computer-readable storage medium such as a read-only memory (“ROM”) 610 or non-volatile RAM (“NVRAM”) for storing basic routines that can help with various tasks such as, but not limited to, starting up the device 600 and/or transferring information between the various components and devices. The ROM 610 or NVRAM can also store other application components necessary for the operation of the device 600 in accordance with various embodiments described herein.

Different embodiments of the device 600 can be configured to operate in a networked environment using logical connections to remote computing devices and computer systems through a network, such as the network 640. The chipset 606 can include functionality for providing network connectivity through a network interface card (“NIC”) 612, which may comprise a gigabit Ethernet adapter or similar component. The NIC 612 can be capable of connecting the device 600 to other devices over the network 640. It is contemplated that multiple NICs 612 may be present in the device 600, connecting the device to other types of networks and remote systems.

In further embodiments, the device 600 can be connected to a storage 618 that provides non-volatile storage for data accessible by the device 600. The storage 618 can, for example, store an operating system 620, applications 622, and data 628, 630, 632, which are described in greater detail below. The storage 618 can be connected to the environment 602 through a storage controller 614 connected to the chipset 606. In certain embodiments, the storage 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 600 can store data within the storage 618 by transforming the physical state of the physical storage units to reflect the information being stored. The specific transformation of physical state can depend on various factors. Examples of such factors can include, but are not limited to, the technology used to implement the physical storage units, whether the storage 618 is characterized as primary or secondary storage, and the like.

For example, the device 600 can store information within the storage 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 600 can further read or access information from the storage 618 by detecting the physical states or characteristics of one or more particular locations within the physical storage units.

In addition to the storage 618 described above, the device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 600. In some examples, the operations performed by a cloud computing network, and or any components included therein, may be supported by one or more devices similar to device 600. Stated otherwise, some or all of the operations performed by the cloud computing network, and or any components included therein, may be performed by one or more devices 600 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 618 can store an operating system 620 utilized to control the operation of the device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 618 can store other system or application programs and data utilized by the device 600.

In various embodiment, the storage 618 or other computer-readable storage media is encoded with computer-executable instructions which, when loaded into the device 600, may transform it from a general-purpose computing system into a special-purpose computer capable of implementing the embodiments described herein. These computer-executable instructions may be stored as application 622 and transform the device 600 by specifying how the processor(s) 604 can transition between states, as described above. In some embodiments, the device 600 has access to computer-readable storage media storing computer-executable instructions which, when executed by the device 600, perform the various processes described above with regard to FIGS. 1-8. In more embodiments, the device 600 can also include computer-readable storage media having instructions stored thereupon for performing any of the other computer-implemented operations described herein.

In still further embodiments, the device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can be configured to provide output to a display, such as a computer monitor, a flat panel display, a digital projector, a printer, or other type of output device. Those skilled in the art will recognize that the device 600 might not include all of the components shown in FIG. 6 and can include other components that are not explicitly shown in FIG. 6 or might utilize an architecture completely different than that shown in FIG. 6.

As described above, the device 600 may support a virtualization layer, such as one or more virtual resources executing on the device 600. In some examples, the virtualization layer may be supported by a hypervisor that provides one or more virtual machines running on the device 600 to perform functions described herein. The virtualization layer may generally support a virtual resource that performs at least a portion of the techniques described herein.

In many embodiments, the device 600 can include a target state logic 624 that can be configured to perform one or more of the various steps, processes, operations, and/or other methods that are described above. While the embodiment shown in FIG. 6 depicts a logic focused on target state conversions, it is contemplated that certain embodiments may utilize a more general “data conversion” logic as well or in lieu of such logic. Often, the target state logic 624 can be a set of instructions stored within a non-volatile memory that, when executed by the controller(s)/processor(s) 604 can carry out these steps, etc. In some embodiments, the target state logic 624 may be an application that resides on a network-connected device, such as, but not limited to, a server, switch, personal or mobile computing device in a single or distributed arrangement. In certain embodiments, the target state logic 624 can be a dedicated hardware device or be configured into a system on a chip package (FPGA, ASIC and the like).

In a number of embodiments, the storage 618 can include element target state data 628. As discussed above, the element target state data 628 can be collected in a variety of ways and may involve data related to multiple network and/or server device configurations. In some embodiments, the element target state data 628 is an easy representation for users and allows them to configure devices using a human-readable format. The element target state data 628 may be associated with a single network device, but may be associated with multiple requests for multiple network devices. In additional embodiments, the element target state data 628 can include not only human-readable configuration input data but may also include details about the person seeking to configure the network device, their security or clearance level, and/or the available hardware data related to the potential configuration options associated with the network devices being configured. This can allow for more secure configurations based on a wider set of factors.

In various embodiments, the storage 618 can include network target state data 630. As described above, network target state data 630 can be configured to be operable by a cloud controller and is optimized for specific processing by that cloud controller. In many embodiments, the network target state data 630 can be generated by converting from element target state data 628 or material target state data 632.

In still more embodiments, the storage 618 can include material target state data 632. As discussed above, material target state data 632 can be raw device data that can be utilized to configure a device. For example, the material target state data 632 can be a binary or executable that can be processed by a network device to change specific configurations based on the input provided by the user in the abstract network configuration setting.

Finally, in many embodiments, data may be processed into a format usable by a machine-learning model 626 (e.g., feature vectors, etc.), and or other pre-processing techniques. The machine learning (“ML”) model 626 may be any type of ML model, such as supervised models, reinforcement models, and/or unsupervised models. The ML model 626 may include one or more of linear regression models, logistic regression models, decision trees, Naïve Bayes models, neural networks, k-means cluster models, random forest models, and/or other types of ML models 626. The ML model 626 may be configured to learn the pattern of historical movement data of various network devices and generate predictions and/or confidence levels regarding current anomalous movements. In some embodiments, the ML model 626 can be configured to determine how to dynamically convert a target state data into another type of target state data.

The ML model(s) 626 can be configured to generate inferences to make predictions or draw conclusions from data. An inference can be considered the output of a process of applying a model to new data. This can occur by learning from at least the access request data, historical data, server device data, profile data, illumination device data, and/or the underlying algorithmic data and use that learning to predict future outcomes and needs. These predictions are based on patterns and relationships discovered within the data. To generate an inference, such as a determination of a suitable pathway, position of tracked person, or specific illumination devices to engage, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 626 may be generated by human/administrator verifications or may compare predicted outcomes with actual outcomes. The training set of the ML model(s) 626 can be provided by the manufacturer prior to deployment and can be based on previously verified data.

Although a specific embodiment for a device suitable for configuration with a network capacity prediction logic suitable for carrying out the various steps, processes, methods, and operations described herein is discussed with respect to FIG. 6, any of a variety of systems and/or processes may be utilized in accordance with embodiments of the disclosure. For example, the device may be in a virtual environment such as a cloud-based network administration suite, or it may be distributed across a variety of network devices or servers. The elements depicted in FIG. 6 may also be interchangeable with other elements of FIGS. 1-5 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

1. A device, comprising:
a processor;
at least one network interface controller configured to provide access to a network; and
a memory communicatively coupled to the processor, wherein the memory comprises a target state logic that is configured to:
receive element target state (ETS) data;
convert the ETS data to network target state (NTS) data;
gather one or more configuration options for the device and determine whether the one or more configuration options match the NTS data;
determine a network configuration based on the NTS data; and
convert the NTS data into material target state (MTS) data for applying the one or more configuration options to the device.

2. The device of claim 1, wherein the ETS data is received from a user configuration interface.

3. The device of claim 2, wherein the user configuration interface is executed within a cloud-based service.

4. The device of claim 3, wherein the cloud-based service is accessible from a web-based interface.

5. The device of claim 2, wherein the user configuration interface is configured to allow for human-readable configuration input.

6. The device of claim 5, wherein the ETS data is based on the human-readable configuration input.

7. The device of claim 1, wherein the NTS data is configured to only be utilized internally within the device.

8. The device of claim 1, wherein target state logic is further configured to transmit the MTS data to one or more network devices on the network.

9. The device of claim 8, wherein the target state logic is further configured to receive updated MTS data from the one or more network devices.

10. The device of claim 9, wherein the target state logic is further configured to convert the updated MTS data to updated NTS data.

11. The device of claim 10, wherein the target state logic is further configured to convert the updated NTS data to updated ETS data.

12. The device of claim 11, wherein the target state logic is further configured to transmit the updated ETS data to a user configuration interface.

13. The device of claim 12, wherein the updated ETS data is configured to be presented to a user via a user configuration interface.

14. A method of processing target state data, comprising:
receiving element target state (ETS) data;
converting the ETS data to network target state (NTS) data;
gathering one or more configuration options for a device and determining whether the one or more configuration options match the NTS data;
determining a network configuration based on the NTS data;
converting the NTS data into material target state (MTS) data;
applying the one or more configuration options to the device; and
transmitting the MTS data to one or more network devices.

15. The method of claim 14, wherein the network configuration is associated with a plurality of settings of the one or more network devices.

16. The method of claim 15, wherein the MTS data is configured to be processed by the one or more network devices.

17. The method of claim 16, wherein the MTS data is further configured to, upon processing by the one or more network devices, to apply the network configuration to the plurality of settings.

18. A device, comprising:
a processor;
at least one network interface controller configured to provide access to a network; and
a memory communicatively coupled to the processor, wherein the memory comprises a target state logic that is configured to:
generate a prompt for abstract network configuration input;
receive abstract network configuration input data;
convert the abstract network configuration data to element target state (ETS) data;
gather one or more configuration options for the device;
adjust the ETS data in response to determining that the one or more configurations were applied;
transmit the ETS data to a target state logic; and
present the ETS data.

19. The device of claim 18, wherein the target state logic is further configured to receive updated ETS data.

20. The device of claim 19, wherein the target state logic is further configured to generate a notification based on the updated ETS data.
